(19) United States
(12) Patent Application Publication
(10) Pub. No.: US 2020/0092264 A1
(43) Pub. Date: Mar. 19, 2020

(54) END-POINT ASSISTED GATEWAY DECRYPTION WITHOUT MAN-IN-THE-MIDDLE

(71) Applicant: Forcepoint LLC, Austin, TX (US)

(72) Inventors: Valtteri RAHKONEN, Helsinki (FI); Kurt NATVIG, Reading (GB); Olli-Pekka NIEMI, Helsinki (FI); Mike GREEN, Minneapolis, MN (US)

(73) Assignee: Forcepoint LLC, Austin, TX (US)

(21) Appl. No.: 16/133,368

(22) Filed: Sep. 17, 2018

(51) Int. Cl. H04L 29/06

(52) U.S. Cl. CPC H04L 63/0428; H04L 63/20; H04L 63/1425; H04L 63/166

(57) ABSTRACT

A method, system, and computer-usable medium are disclosed for, responsive to receipt at a security device of a connection request from a client to a server receiving a message from the client to the server, extracting from a memory associated with the client a secret for performing decryption of application messages communicated from the server to the client, and using the secret to decrypt the application messages to perform at least one of monitoring and inspection of the application messages as decrypted in accordance with a security policy, while allowing the client and the server to maintain an end-to-end connection without intermediate termination at the security device.

### FIELD OF DISCLOSURE

The present invention relates in general to the field of computers and similar technologies, and in particular to software utilized in this field. Still more particularly, it relates to a method, system, and computer-usable medium for performing end-point assisted gateway decryption with respect to network traffic without a man-in-the-middle device.

### BACKGROUND

While network communication among networked computers, including the use of the Internet, has many advantages, one downside to network communication is that it may render networked computers susceptible to malicious attacks from viruses or other intrusions. One common way in which to protect an endpoint device from malicious attacks is the use of encryption, such as Transport Layer Security (TLS) encryption.

However, creators of malware are increasingly using TLS to distribute the malicious content, with some studies showing that about 60% of malicious payloads were using TLS. For example, malware may use standard legitimate services such as a publicly-available email service for remote control and distribution of their malicious content through social media. Malware can be distributed in such manner because not all organizations perform TLS decryption and thus the malicious content can be delivered undetected both to command and control an already exploited target or deliver attacks. As a solution to this problem, modern in-line devices (e.g., firewalls and proxy-based gateways) may perform TLS man-in-the-middle (MITM) decryption. A downside of MITM solutions is that an MITM must terminate client and server TLS connections and offer a new server certificate signed by the MITM solutions certificate authority for the client unless operating in the server protection mode where the server certificate and keys are known for the MITM device. This means that client devices must trust the MITM device certificate to offer these services. While it is possible to install an MITM device certificate to the client device's certificate store, some applications may use certificate pinning to expect a specific certificate on the client. This approach may work for some client applications (e.g., browsers), but such approach may not work on some other applications that have their internal trust included (e.g., certificate pinning or in applications that do not trust user imported certificate authorities or client applications that do not support such a trust setting. As a result of this, either all traffic is decrypted and some applications do not work, or some part of the encrypted traffic must not be decrypted. In addition to server certificate pinning problems, an MITM may also break the mutual authentication present when the server requires that the client authenticate itself with a certificate. Such mutual authentication is typically used with applications that require reliably identifying the client to give the client authorization to access sensitive data.

### SUMMARY

In accordance with the teachings of the present disclosure, certain disadvantages and problems associated with existing approaches to network and data security have been reduced or eliminated.

In accordance with embodiments of the present disclosure, a computer-implementable method for managing network communication may include, responsive to receipt at a security device of a connection request from a client to a server receiving a message from the client to the server, extracting from a memory associated with the client a secret for performing decryption of application messages communicated from the server to the client, and using the secret to decrypt the application messages to perform at least one of monitoring and inspection of the application messages as decrypted in accordance with a security policy, while allowing the client and the server to maintain an end-to-end connection without intermediate termination at the security device.

In accordance with these and other embodiments of the present disclosure, a system may include a processor, a data bus coupled to the processor, and a non-transitory, computer-readable storage medium embodying computer program code, the non-transitory, computer-readable storage medium being coupled to the data bus, the computer program code interacting with a plurality of computer operations and comprising instructions executable by the processor. The instructions may be configured for, responsive to receipt at a security device of a connection request from a client to a server receiving a message from the client to the server, extracting from a memory associated with the client a secret for performing decryption of application messages communicated from the server to the client, and using the secret to decrypt the application messages to perform at least one of monitoring and inspection of the application messages as decrypted in accordance with a security policy, while allowing the client and the server to maintain an end-to-end connection without intermediate termination at the security device.

In accordance with these and other embodiments of the present disclosure, a non-transitory, computer-readable storage medium may embody computer program code, the computer program code comprising computer executable instructions configured for, responsive to receipt at a security device of a connection request from a client to a server receiving a message from the client to the server, extracting from a memory associated with the client a secret for performing decryption of application messages communicated from the server to the client, and using the secret to decrypt the application messages to perform at least one of monitoring and inspection of the application messages as decrypted in accordance with a security policy, while allowing the client and the server to maintain an end-to-end connection without intermediate termination at the security device.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the example, present embodiments and certain advantages thereof may be acquired by referring to the following description taken in conjunction with the accompanying drawings, in which like reference numbers indicate like features, and wherein:

FIG. 1 illustrates an example information handling system in which the methods and systems disclosed herein may be implemented, in accordance with embodiments of the present disclosure;

FIG. 2 illustrates a block diagram of a system for performing end-point assisted gateway decryption without man-in-the-middle connection termination, in accordance with embodiments of the present disclosure; and

FIG. 3 illustrates a flow chart of an example method for performing end-point assisted gateway decryption without man-in-the-middle connection termination, in accordance with embodiments of the present disclosure.

### DETAILED DESCRIPTION

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a mobile device such as a tablet or smartphone, a consumer electronic device, a connected “smart device,” a network appliance, a network storage device, a network gateway device, a server or collection of servers or any other suitable device and may vary in size, shape, performance, functionality, and price. The information handling system may include volatile and/or non-volatile memory, and one or more processing resources such as a central processing unit (CPU) or hardware or software control logic. Additional components of the information handling system may include one or more storage systems, one or more wired or wireless interfaces for communicating with other networked devices, external devices, and various input and output (I/O) devices, such as a keyboard, a mouse, a microphone, speakers, a track pad, a touchscreen and a display device (including a touch sensitive display device). The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or solid state drive), a sequential access storage device (e.g., a tape disk drive), optical storage device, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

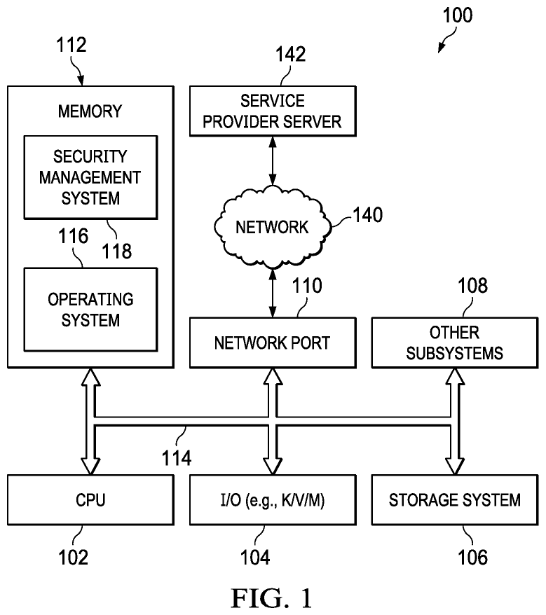

FIG. 1 illustrates an example information handling system 100 in which the methods and systems disclosed herein may be implemented, in accordance with embodiments of the present disclosure. Information handling system 100 may include a processor (e.g., central processor unit or “CPU”) 102, input/output (I/O) devices 104 (e.g., a display, a keyboard, a mouse, and/or associated controllers), a storage system 106, and various other subsystems 108. In various embodiments, information handling system 100 may also include network port 110 operable to couple to a network 140, which may likewise be accessible by a service provider server 142. Information handling system 100 may also include system memory 112, which may be coupled to the foregoing via one or more buses 114. System memory 112 may store operating system (OS) 116 and in various embodiments may also include a security management system 118. In some embodiments, information handling system 100 may be able to download security management system 118 from service provider server 142. In other embodiments, security management system 118 may be provided as a service from the service provider server 142.

In various embodiments, security management system 118 may be configured to enable end-point assisted gateway decryption without man-in-the-middle connection termination, as described in greater detail below. In some embodiments, security management system 118 and the functionality thereof may improve processor efficiency, and thus the efficiency of information handling system 100, by performing network security operations with greater efficiency and with decreased processing resources as compared to existing approaches for similar network security operations. In these and other embodiments, security management system 118 and the functionality thereof may improve effectiveness in ensuring network security, and thus the effectiveness of information handling system 100, by performing network security operations with greater effectiveness as compared to existing approaches for similar network security operations. As will be appreciated, once information handling system 100 is configured to perform the functionality of security management system 118, information handling system 100 becomes a specialized computing device specifically configured to perform the functionality of security management system 118, and is not a general purpose computing device. Moreover, the implementation of functionality of security management system 118 on information handling system 100 improves the functionality of information handling system 100 and provides a useful and concrete result of improving network security and performing network security operations with greater efficiency and with decreased processing resources by enabling distributed client protection of networked client devices as described herein.

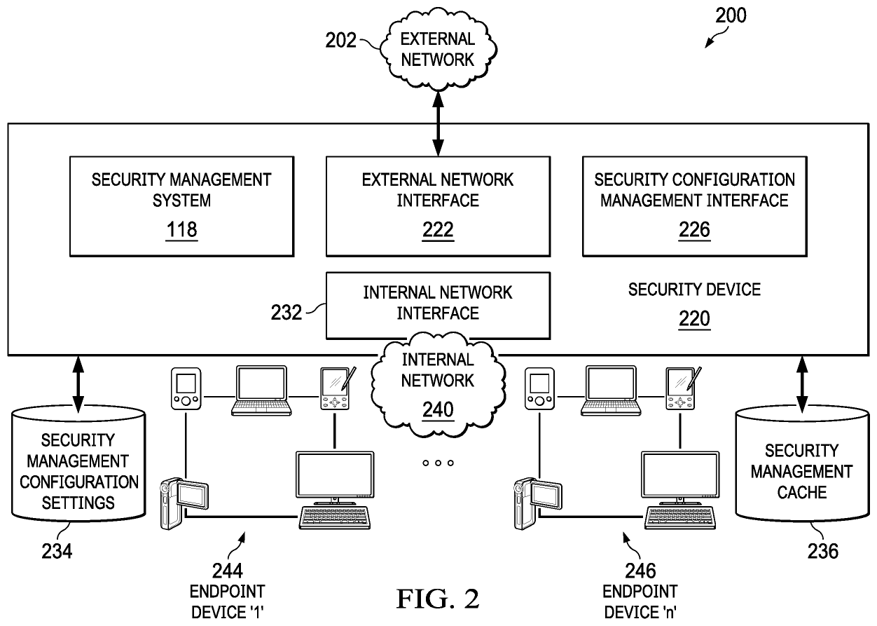

FIG. 2 illustrates a block diagram of a system 200 for performing end-point assisted gateway decryption without man-in-the-middle connection termination, in accordance with embodiments of the present disclosure. In some embodiments, a security device 220 may include an external network interface 222, a security configuration management interface 226, an internal network interface 232, and a security management system 118. Security device 220 may be implemented using any suitable information handling system 100, including without limitation a gateway, a firewall, an intrusion prevention system, an intrusion detection system, or any other suitable security device capable of implementing security management system 118. In some embodiments, security device 220 may be implemented as an individual security device 220, a virtual context security device 220, or a security device 220 cluster.

Security device 220 may also include in some embodiments a repository of security management configuration settings 234 and a security management cache 236. In certain embodiments, security configuration management interface 226 may be implemented to receive instructions relating to network security policy decisions from security management system 118.

Skilled practitioners of the art will be familiar with network communication involving communicating Internet Protocol (IP) datagrams, or packets, to a target group of recipient network addresses in real-time or near real-time. In some embodiments, the target group recipient network addresses may be respectively associated with a corresponding endpoint device ‘1’ 244 through ‘n’ 246. As used herein, an endpoint device refers to an information processing system such as a personal computer, a laptop computer, a tablet computer, a smart phone, a mobile telephone, a digital camera, a video camera, or other device capable of storing, processing and communicating data via a network, such as an internal network 240 interfaced to internal network interface 232. In various embodiments, the communication of the data may take place in real-time or near-real-time.

Embodiments of the invention may reflect an appreciation that network communication may represent an efficient means for communicating useful information. However, those of skill in the art will likewise appreciate that it may be desirable to secure such network communication to prevent malicious attacks on network components. Many existing solutions for providing security in a network environment have disadvantages, as described in the Background section of this application. However, security management system 118 as disclosed herein may overcome these disadvantages by enabling end-point assisted gateway decryption without man-in-the-middle connection termination, as described herein.

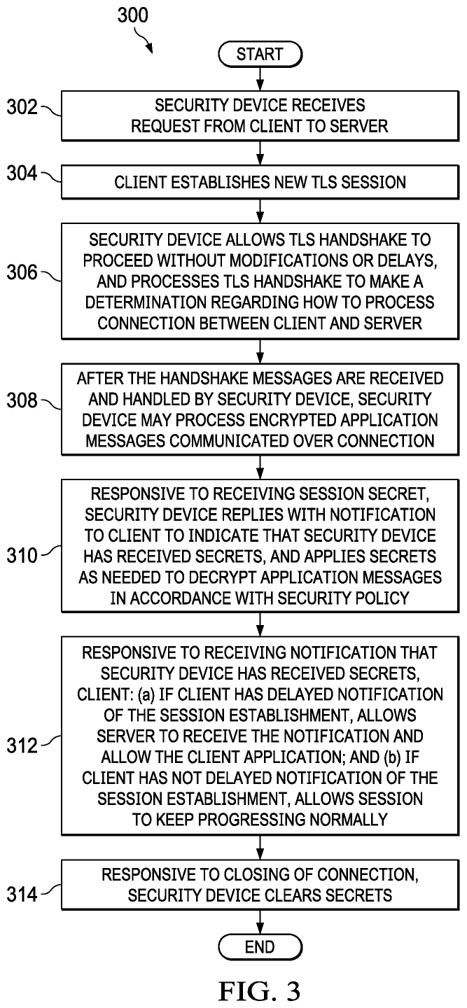

FIG. 3 illustrates a flow chart of an example method 300 for performing end-point assisted gateway decryption without man-in-the-middle connection termination, in accordance with embodiments of the present disclosure. According to some embodiments, method 300 may begin at step 302. As noted above, teachings of the present disclosure may be implemented in a variety of configurations of information handling system 100. As such, the preferred initialization point for method 300 and the order of the steps comprising method 300 may depend on the implementation chosen.

At step 302, a security device (e.g., security device 220, a gateway, etc.) may receive a request from a client (e.g., an endpoint device 244, 246) to a server (e.g., a server coupled to external network 202) for network traffic from the server. At step 304, the client may establish a new TLS session. During session establishment, the client may set TLS session parameters (e.g., disable unsupported ciphers, TLS extensions, etc.) to ensure that traffic of the connection between the client and the server can be decrypted by the security device. In embodiments in which TLS secrets are created in the client (e.g., the premaster secret and/or the master secret are generated in the client and/or encryption keys are negotiated in the client), the client may distribute the secrets to the security device. In some embodiments, the client may hold notification of the established TLS session to the server until the client has received a response from the security device in order to ensure that all traffic can be processed prior to reaching the server. In other embodiments, the client may instead pass the notification of established TLS session immediately to the server to avoid delay in executing an application on the server. At step 306, the security device may allow the TLS handshake to proceed without modifications or delays, and may process the TLS handshake to make a determination regarding how to process the connection between the client and the server. For example, if the TLS secrets are already known at the time of handshake, the security device may read handshake messages and extract information (e.g., encryption keys, random numbers, etc.) needed to perform decryption from a memory associated with the client. As another example, if the TLS secrets are not known at the time of handshake, the security device may store the handshake messages for later use. As a further example, if during the handshake the security device determines that a connection must not be decrypted, the security device may clear its copy of the TLS secrets, as such TLS secrets will not be needed. In some embodiments, the security device may allow the handshake to proceed without modification, although in some embodiments, the security device may make or otherwise allow for modifications to the handshake, for example to restrict the negotiated cryptographic suite set forth in the handshake. However, if allowing modifications, the security device may exit method 300 and proceed in a man-in-the-middle mode in order to support the modifications or any communication in which the client device has not enforced TLS parameters.

At step 308, after the handshake messages are received and handled by the security device, the security device may process encrypted application messages communicated over the connection. If decryption of the application messages is not needed and the TLS session is not recorded in accordance with a security policy, the security device may perform inspection of the encrypted messages without decryption, and may allow application messages complying with a security policy for the inspection to proceed to the client. In the event that the security device detects that encrypted application messages are present in the traffic and the secrets are not yet known, the security device may delay sending of the application messages to the client when a security policy dictates that the TLS session is to be decrypted and the client is to be protected. In the event that the security device detects that encrypted application messages are present in the traffic and the secrets are not yet known, the security device may send the application messages to the client without delay and store the encrypted messages for later inspection when a security policy dictates that the TLS session is to be decrypted and the connection is to be monitored. In the event that the security device detects that encrypted application messages are present in the traffic and the secrets are known (e.g., TLS premaster and/or master secret is known and/or negotiated encryption key is known), the security device may perform decryption on the application messages and handle the application messages in accordance with the security policy. In the event that a security policy dictates that the session is to be recorded, the security device may store the encrypted application messages. If at any point during the session re-keying is performed for the connection, the security device may store the updated secret information. The security device may also take all other actions to comply with a security policy. For example, if a security policy requires operations to the traffic such as modifying the content or delaying messages through the security device, the security device may modify or hold the encrypted application messages when needed to comply with the security policy.

At step 310, responsive to receiving the session secrets (e.g., TLS premaster and/or master secret and/or negotiated encryption), the security device may reply with a notification to the client to indicate that the security device has received the secrets, and apply the secrets as needed to decrypt application messages in accordance with the security policy. If decryption is not needed by the security device, the security device may not store the secrets. If the security policy dictates that the session is to be recorded, the security device may store the secrets with application messages for performing later decryption of the application messages. If the security device has buffered handshake messages, the security devices may process the handshake messages to extract information (e.g., encryption keys, random numbers, etc.) from the handshake messages needed to perform decryption. If the security device has buffered encrypted application messages, the security device may decrypt such application messages and inspect and monitor application messages in accordance with the security policy. If the security device has buffered and delayed encrypted application messages, the security device may decrypt such application messages and inspect and handle application messages in accordance with the security policy, and release and send application messages to the client device after decryption if allowed by the security policy.

At step 312, in response to receiving the notification that the security device has received the secrets, the client may: (a) if the client has delayed the notification of the session establishment, allow the server to receive the notification and allow the client application; or (b) if the client has not delayed the notification of the session establishment, allow the session to keep progressing normally.

At step 314, responsive to the closing of the connection, the security device may clear the secrets. However, when needed (e.g., when a session is recorded), the secrets may be stored with application messages for later access.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using CPU 102, security management system 118 executing thereon, and/or any other system operable to implement method 300. In certain embodiments, method 300 may be implemented partially or fully in software and/or firmware embodied in computer-readable media.

Although the foregoing contemplates that security management system 118 resides in security device 220, in some embodiments, security management system 118 may be implemented by a device external to security device 220, including without limitation a device within external network 202. In yet other embodiments, the functionality described above, particularly that of method 300, may be implemented within a client device and/or a cloud-based inspection system.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding this disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A computer-implementable method for managing network communication, comprising:
responsive to receipt at a security device of a connection request from a client to a server:
receiving a message from the client to the server;
extracting from a memory associated with the client a secret for performing decryption of application messages communicated from the server to the client; and
using the secret to decrypt the application messages to perform at least one of monitoring and inspection of the application messages as decrypted in accordance with a security policy, while allowing the client and the server to maintain an end-to-end connection without intermediate termination at the security device.

2. The method of claim 1, wherein the secret comprises one of a Transport Layer Security premaster secret, a Transport Layer Security master secret, and a negotiated encryption key.

3. The method of claim 1, wherein decrypting the application messages comprises decrypting the messages using Transport Layer Security decryption.

4. The method of claim 1, further comprising responsive to receiving a handshake message from the client to the server prior to receiving the message with the secret, storing the handshake message for later use once the message with the secret is received.

5. The method of claim 1, wherein the message having the secret comprises a handshake message from the client to the server.

6. The method of claim 1, further comprising responsive to receiving an application message prior to receiving the message with the secret, storing the application message for later decryption once the message with the secret is received.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
responsive to receipt at a security device of a connection request from a client to a server:
receiving a message from the client to the server;
extracting from a memory associated with the client a secret for performing decryption of application messages communicated from the server to the client; and
using the secret to decrypt the application messages to perform at least one of monitoring and inspection of the application messages as decrypted in accordance with a security policy, while allowing the client and the server to maintain an end-to-end connection without intermediate termination at the security device.

8. The system of claim 7, wherein the secret comprises one of a Transport Layer Security premaster secret, a Transport Layer Security master secret, and a negotiated encryption key.

9. The system of claim 7, wherein decrypting the application messages comprises decrypting the messages using Transport Layer Security decryption.

10. The system of claim 7, further comprising responsive to receiving a handshake message from the client to the server prior to receiving the message with the secret, storing the handshake message for later use once the message with the secret is received.

11. The system of claim 7, wherein the message having the secret comprises a handshake message from the client to the server.

12. The system of claim 7, further comprising responsive to receiving an application message prior to receiving the message with the secret, storing the application message for later decryption once the message with the secret is received.

13. A non-transitory, computer-readable storage medium embodying computer program code, the computer program code comprising computer executable instructions configured for:
responsive to receipt at a security device of a connection request from a client to a server:
receiving a message from the client to the server;
extracting from a memory associated with the client a secret for performing decryption of application messages communicated from the server to the client; and
using the secret to decrypt the application messages to perform at least one of monitoring and inspection of the application messages as decrypted in accordance with a security policy, while allowing the client and the server to maintain an end-to-end connection without intermediate termination at the security device.

14. The storage medium of claim 13, wherein the secret comprises one of a Transport Layer Security premaster secret, a Transport Layer Security master secret, and a negotiated encryption key.

15. The storage medium of claim 13, wherein decrypting the application messages comprises decrypting the messages using Transport Layer Security decryption.

16. The storage medium of claim 13, further comprising responsive to receiving a handshake message from the client to the server prior to receiving the message with the secret, storing the handshake message for later use once the message with the secret is received.

17. The storage medium of claim 13, wherein the message having the secret comprises a handshake message from the client to the server.

18. The storage medium of claim 13, further comprising responsive to receiving an application message prior to receiving the message with the secret, storing the application message for later decryption once the message with the secret is received.
